(19) United States
(12) Patent Application Publication
(10) Pub. No.: US 2026/0134443 A1
(43) Pub. Date: May 14, 2026

(54) Portable Apparatus for Capturing Human Test Subject Response Data by Facial Observation, Particularly for Product Testing

(71) Applicant: Frito-Lay Trading Company GmbH, Berne (CH)

(72) Inventors: Stacie Tibos, Berkshire (GB); Inga Kutepova, Berkshire (GB); Christopher J. Koh, Cincinatti, OH (US)

(21) Appl. No.: 18/944,890

(22) Filed: Nov. 12, 2024

(51) Int. Cl. G06Q 30/0201; G06V 40/16; G06V 40/20; H04N 23/90; H04R 1/08; H04R 1/10

(52) U.S. Cl. CPC G06Q 30/0201; G06V 40/176; G06V 40/20; H04N 23/90; H04R 1/08; H04R 1/1016

(57) ABSTRACT

A hand portable screen includes three portions connected in series relation, each portion having a camera for capturing image data from a field of view in front of a front surface of the respective portion of the screen. The screen is free standing when configured in an upright use position on a horizontal surface, e.g. a tabletop, so that the three front surfaces form three sides of a forwardly open recess. The side portions may be adjustable to converge the fields of view on a user sitting in front of the screen, for example, during an edible product test. Microphones may be provided, optionally in-ear, to capture sound data simultaneously with the image data from the cameras. The screen may be deployed to provide an individual test environment, for example, for testing snack food in an informal location.

This disclosure relates to arrangements for capturing data from a human test subject by detailed observation of the user's face, particularly for the purpose of assessing a product that is used or consumed by the test subject, where the assessment is based on the user's interaction with or reaction to the product. The product may be an edible product, for example, a snack food product.

### BACKGROUND

It is well known to capture both sound data and image data from a human test subject for various purposes including medical assessment or monitoring, product testing, entertainment or telecommunications.

For example, it is known to capture chewing sounds via a microphone housed in an ear bud, as discussed in

Papapanagiotou V et al: A Novel Chewing Detection System Based on PPG, Audio, and Accelerometry. IEEE J Biomed Health Inform. 2017 May; 21(3):607-618. doi: 10.1109/JBHI.2016.2625271. Epub 2016 Nov. 4. PMID: 27834659.

US2024/0215931 discloses a foldable booth having cameras for capturing a full body image of a patient during a medical examination.

During or after capture, both sound and image data can be processed to extract useful information.

For example, image data can be processed by selecting reference points on the user's face, and then monitoring relative movement between those points so as to identify movement of the facial muscles. When testing an edible product, this can help in assessing the way the user chews the product so as to better understand how the product texture or other mechanical characteristics affect the user's experience of the product.

Facial movements can also be processed to identify the user's affective reaction to the product—for example, by recognizing signs of satisfaction or dissatisfaction.

Although it is generally known to arrange sensors such as cameras and microphones to capture test subject data in a clinical environment, or for example on a film set or during an online meeting, such arrangements can be ill adapted for use in monitoring a human test subject in order to capture data that faithfully represents a typical user reaction to a product, particularly an edible product, in a normal use situation.

### SUMMARY

The present disclosure describes a data capture apparatus that is more suitable for such applications. In accordance with the present disclosure there is provided an apparatus including a hand-portable screen as described in claim 1. In this regard, the screen is extendible from a compact configuration to a use configuration, and in the use configuration is configured to be freestanding in an upright use position on a horizontal flat surface.

The screen includes a middle portion and two side portions. Each of the portions has a respective front surface, wherein the front surface of each of the side portions terminates at a respective free edge. Each of the front surfaces has a respective height and width, wherein in the upright use position the height extends in a vertical dimension and the width extends in a horizontal dimension. Each of the portions has a thickness smaller than the height and width of its front surface.

The portions are connected together in series relation in the use configuration, so that the front surface of the middle portion extends in its width between the front surfaces of the two side portions, and the front surface of each side portion extends in its width between its respective free edge and the front surface of the middle portion.

In the upright use position, the front surfaces define three inwardly facing sides of a recess having a front opening bounded by the free edges of the side portions, with the front opening having a width between the free edges greater than the width of the front surface of the middle portion.

Each portion of the screen may include a respective camera. The camera of each portion may be arranged to capture image data from a respective field of view in front of the respective front surface.

The apparatus may further include a power supply means for supplying power to the cameras, and a data management means, including a memory, for collecting and storing the image data captured by the cameras. The data management means may include various data collection devices, computing devices, computing server systems, and/or data stores, configured to communicate with the cameras and/or with each other over one or more networks including, but not limited to one or more LANs (local area networks), WANs (wide area networks), and/or the Internet.

In this specification, the term “screen” is used in the sense of a body that screens or partially surrounds the user, who faces the front surfaces of the screen in the use position. The screen may be made for example from wood, metal, plastics, textile, or any other suitable materials. It may be substantially opaque so that the user is screened from the view of other persons behind the screen, or is screened from distractions that would otherwise be visible to the user, for example, while seated facing the screen and testing an edible product. In use, the cameras incorporated into the screen capture image data from their respective fields of view, without being visually intrusive. Thus, the user is able to concentrate on the product test or other task while image data and, optionally, also sound data is collected for later analysis.

The described apparatus recognizes that a user's response to a snack food or other edible product being tested will be determined, not only by the user's sensory experience and affective reaction to the product, but also by the user's affective reaction to the test environment.

For example, if a randomly selected human test subject is invited to consume a snack food product in a clinical environment, they may unconsciously modify their behavior and so consume the product more cautiously or carefully than they would in a normal use environment, which will skew the results of the test.

Similarly, a test subject who is aware of multiple cameras recording their actions may feel inhibited from consuming the product with typical gusto.

Consequently, the described apparatus recognizes that a snack food product test may be better carried out in an informal environment where the user would typically consume such products, such as an outdoor environment or in a pub or cafe where other people may be present and where the user can interact with the product in a relaxed and natural way.

At the same time, it is desirable to ensure that the data capture is as far as possible standardized, so that tests can be repeated and compared between different test subjects.

This is ensured by the arrangement of the cameras and, preferably, also microphones in combination with the screen that defines a forwardly facing recess in use. This arrangement allows the user to behave more naturally in an informal setting while collecting test data by close observation of the user. The screen is hand portable so that it can be carried and set up on a table in any convenient location for the test, such as a pub or a cafe or an outdoor seating area.

Further features and advantages will be appreciated from the illustrative embodiment which will now be described, purely by way of example and without limitation to the scope of the claims, and with reference to the accompanying drawings.

### BRIEF DESCRIPTION OF THE DRAWINGS

FIG. 1 is a front view of a screen in accordance with an embodiment of the apparatus, in the folded or compact configuration.

FIG. 2 is a top view of the screen in the compact configuration.

FIG. 3 is a front view of the screen unfolded in the upright use position.

FIG. 4 shows (at relatively larger scale) a pair of in-ear housings containing microphones for use with the screen.

FIG. 5 is a plan view of the screen in the upright use position.

FIGS. 6 and 7 show the screen with the front and side portions opened out in a straight-line configuration so that the front surfaces all lie in a common plane, wherein FIG. 6 is a front view, and FIG. 7 is a top view. It will be appreciated that the screen does not form a stable self-standing unit in this configuration, which is shown purely to better illustrate its dimensions.

FIG. 8 shows the screen standing on a table in the upright use position.

FIG. 9 shows the screen standing on a table in the upright use position during an edible product test.

FIGS. 10 and 11 are two frequency traces captured from an edible product test as shown in FIG. 9, respectively by an in-ear microphone (FIG. 10) and a local microphone mounted on the screen (FIG. 11).

FIGS. 12-14 are three more frequency traces captured from edible product tests as shown in FIG. 9 using an in-ear microphone.

FIG. 15 is a conceptual diagram of a system for collecting, storing, and/or processing image data captured by one or more cameras and/or sound data captured by one or more microphones.

### DESCRIPTION

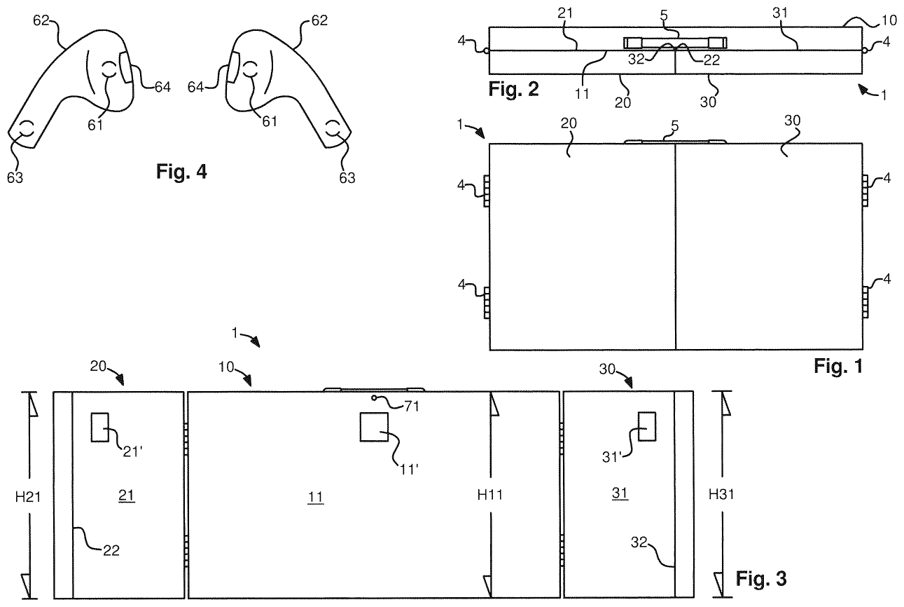

Referring to FIGS. 1-3 and 5-8, in an embodiment, the apparatus includes a screen 1 having a middle portion 10 and two side portions 20, 30. Each of the three portions 10, 20, 30 has a respective front surface 11, 21, 31. The front surface 21, 31 of each of the side portions 20, 30 terminates at a respective free edge 22, 32.

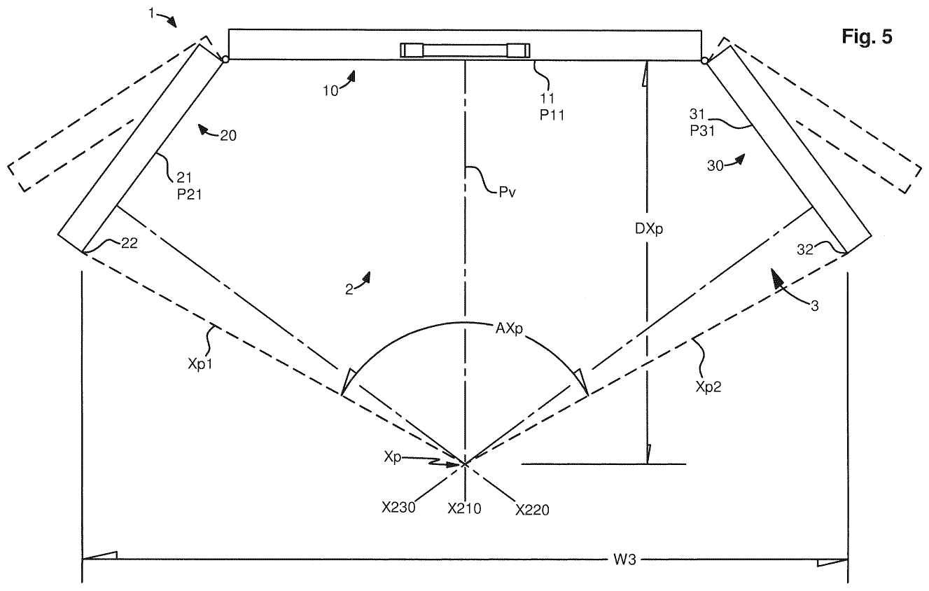

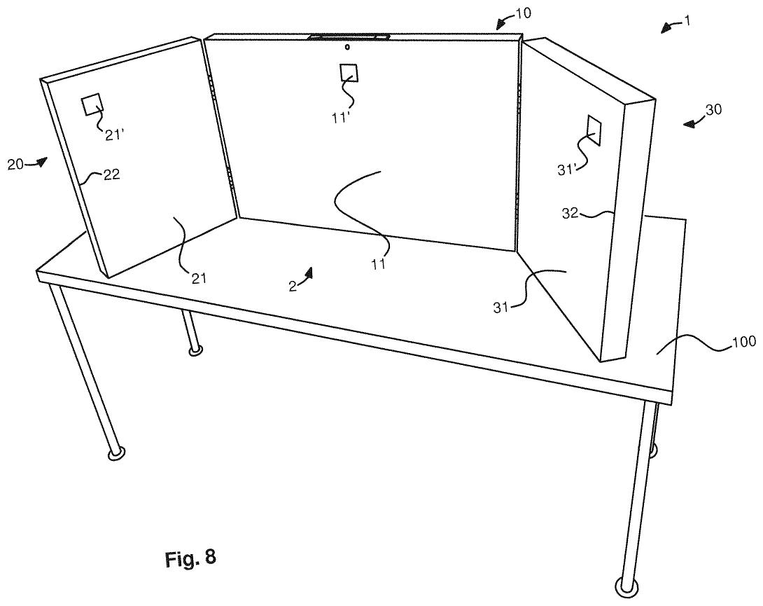

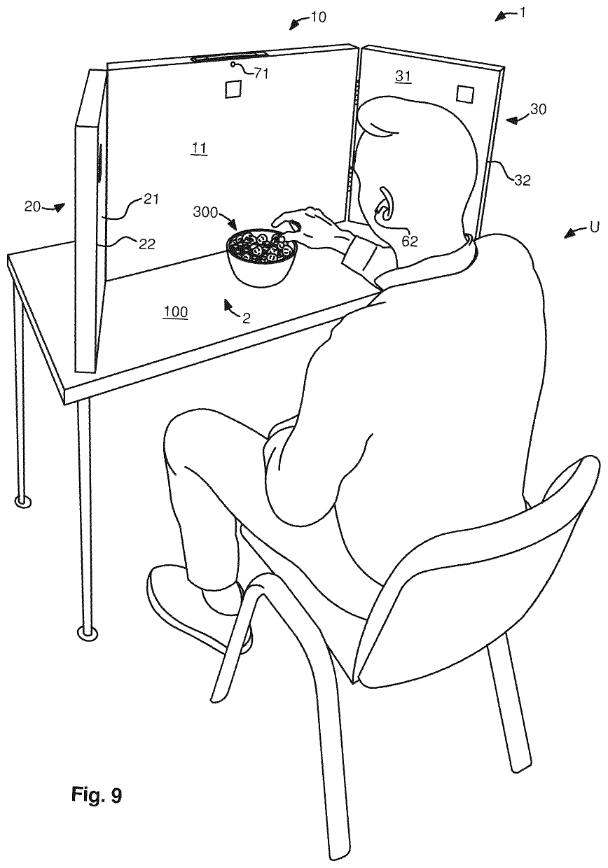

The screen 1 is hand-portable and extendible (e.g. unfoldable or unpackable) from a compact configuration (FIGS. 1 and 2) to a use configuration (FIGS. 3, 5, 8 and 9). In the use configuration the screen 1 is configured to be freestanding when arranged in an upright use position on a horizontal flat surface 100, which conveniently may be a tabletop as shown in FIGS. 8 and 9 on which the product under test (e.g. snack food 300) may be placed for the user U. The freestanding configuration is obtained by arranging the side portions to extend out of the plane P11 of the front surface 11 of the middle portion 10 when considered in plan view (i.e. from above), as best seen in FIG. 5.

Each of the front surfaces 11, 21, 31 has a respective height H11, H21, H31 and width W11, W21, W31. The plane P11, P21, P31 of each of the front surfaces 11, 21, 31 may be vertical in the upright use position, as illustrated in FIGS. 8 and 9, but alternatively may have a somewhat inclined orientation. In either case, when considered in the upright use position, the height H11, H21, H31 of the front surface of each portion extends in a vertical dimension and the width W11, W21, W31 extends in a horizontal dimension. Each of the portions 10, 20, 30 has a thickness T10, T20, T30 smaller than the height H11, H21, H31 and width W11, W21, W31 of its respective front surface 11, 21, 31.

As illustrated, each of the three portions 10, 20, 30 may be substantially rigid, and each front surface 11, 21, 31 may be contained substantially in a respective flat plane P11, P21, P31. By way of example, each portion may be configured as a light weight, hollow body with flat, oppositely facing front and back panels joined by a frame, with the front panels defining the front surfaces. Other structural arrangements are possible.

As illustrated, each front surface 11, 21, 31 may be substantially rectangular, and the front surfaces may be substantially equal in their height H11, H21, H31.

The portions 10, 20, 30 are connected together in series relation, at least in the use configuration, so that the front surface 11 of the middle portion 10 extends in its width W10 between the front surfaces 21, 31 of the two side portions 20, 30, and the front surface 21, 31 of each side portion 20, 30 extends in its width W21, W31 between its respective free edge 22, 32 and the front surface 11 of the middle portion 10. Preferably the portions are connected together permanently, but alternatively they may be releasably connected in series relation in the use configuration so that they can be disassembled to the compact configuration.

As illustrated, the side portions 20, 30 may be pivotably connected to the central portion 10, e.g. by hinges 4, and foldable to the compact configuration, so that in the compact configuration, the front surfaces 21, 31 of the side portions 20, 30 are arranged in confronting relation to the front surface 11 of the middle portion 10, as best seen in FIG. 2. When unfolded to the use configuration the front surfaces 11, 21, 31 may be separated by narrow gaps as shown, which preferably are narrow enough, as shown, that they do not substantially affect the function of the screen.

For a particularly compact configuration, as illustrated, the width W21, W31 of the front surface 21, 31 of each of the side portions 20, 30 may be approximately half of the width W11 of the front surface 11 of the middle portion 10 so that the free edges 22, 32 of the side portions meet or nearly meet together in the middle when folded.

A handle 5 may be provided, e.g. on the narrow top surface of the middle portion 10 as shown, so that the folded screen can be carried conveniently by hand.

As best shown in FIG. 5 and FIGS. 8 and 9, in the upright use position the front surfaces 11, 21, 31 define three inwardly facing sides of a recess 2 which has a front opening 3 bounded by the free edges 22, 32 of the side portions 20, 30. The front opening 3 has a width W3 between the free edges 22, 32 greater than the width W11 of the front surface 11 of the middle portion 10, so that the recess 2 widens forwardly, away from the middle portion 10, and towards the user U when seated at a table in front of the screen 1 as shown in FIG. 9.

As in the illustrated embodiment, the use configuration may be freely adjustable (infinitely or step-wise) by the user. Optionally, the use configuration may be defined by stays or catches or other connecting or locking elements of the apparatus (not shown) so as to constrain the respective portions to a defined use configuration or a limited number of alternative, defined use configurations.

As best seen in FIG. 5, when considered in plan view in the upright use position as illustrated, the front surfaces 21, 31 of the side portions 20, 30 may be mirror-symmetric about a vertical plane Pv bisecting, and perpendicular to, the front surface 11 of the middle portion 10.

### Cameras

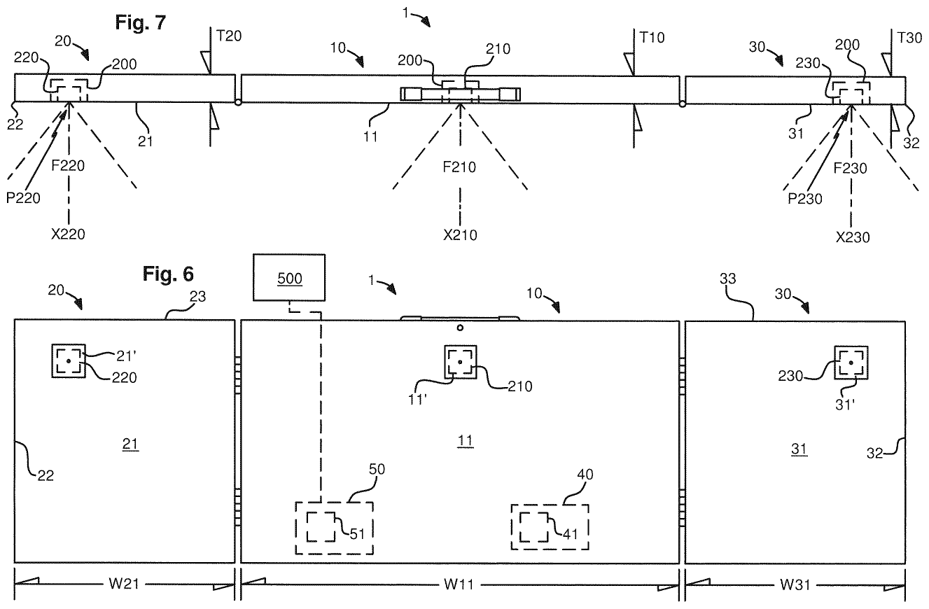

Referring particularly to FIGS. 6 and 7, each portion 10, 20, 30 of the screen 1 includes a respective camera 210, 220, 230 which is arranged to capture image data from a respective field of view F210, F220, F230 in front of the front surface 11, 21, 31 of that respective portion. The image data may include moving image data. The image data can be used to identify the movement of the user's facial muscles which in turn provides an indication of the user's response to the product under test.

As illustrated, the camera 210, 220, 230 of each portion 10, 20, 30 of the screen 1 may be arranged behind the respective front surface 11, 21, 31 of the respective portion of the screen.

The camera of each portion may be arranged behind the respective front surface 11, 21, 31 to capture image data through a transparent portion or window 11′, 21′, 31′ of the respective front surface 11, 21, 31, or alternatively, through an aperture formed in the respective front surface 11, 21, 31.

Where the camera of each portion is arranged behind the respective front surface to capture image data through a transparent portion 11′, 21′, 31′ of the front surface, each portion of the screen may be arranged to define a respective cavity 200 containing the respective camera 210, 220, 230, and to substantially exclude ambient light from entering the cavity 200 other than via the transparent portion 11′, 21′, 31′.

In this arrangement it is difficult to see the camera through the transparent portion 11′, 21′, 31′, which as shown may be a small window flush with the rest of the front surface of the respective portion of the panel. This allows the user to focus on the product test or other task without being distracted by the presence of the cameras.

Each camera may be releasably mounted in its respective cavity 200, e.g. via a clip, so it can be swapped out if required.

A central axis X210, X220, X230 of the field of view of each camera can be considered to pass centrally through the lens of the camera, which in FIG. 6 is indicated by the small dot just visible in the centre of each window 11′, 21′, 31′, to intersect the front surface 11, 21, 31 of the respective portion at a point referred to herein as a location point.

As shown in FIG. 7, the central axis X220, X230 of the field of view F220, F230 of the camera 220, 230 of each of the side portions 20, 30 may intersect the front surface 21, 31 of the respective side portion 20, 30 at a respective location point P220, P230 which is less than 30% of the width W21, W31 of the front surface 21, 31 of the respective side portion 20, 30 from the free edge 22, 32 of the respective side portion 20, 30.

Moreover, as can be appreciated from FIG. 6, each of those location points P220, P230 may be less than 30% of the height H31, H32 of the respective front surface 21, 31 of the respective side portion 20, 30 from an upper edge 23, 33 of the respective side portion 20, 30 when considered in the upright use position.

This places the cameras of the side portions close to their upper corners and so provides a relatively wide angle of view of the user U, roughly at the level of the user's head, when seated in front of the screen 1.

Referring to FIG. 5, when considered in plan view in the upright use position of the screen 1, respective central axes X210, X220, X230 of the fields of view F210, F220, F230 of the cameras 210, 220, 230 of at least the side portions 20, 30 (and, where the screen is mirror-symmetric as shown, also of the middle portion 10) may converge at a point of convergence Xp located outside the recess 2. In use, the user's head may be close to the point of convergence Xp, so that the cameras provide multiple views of the user's head from different directions, making it easier to assess the movements of the facial musculature.

The side portions 20, 30 may be angularly adjustable, relative to the middle portion 10, to vary, simultaneously, in the upright use position, the width W3 of the front opening 3 of the recess 2, and a distance DXp of the point of convergence Xp from the middle portion 10. The angular adjustment is illustrated in FIG. 5 by the alternative positions of the side portions 20, 30.

This allows the screen 1 to be adjusted easily to suit the preferred seated position of the user U carrying out a product test, so as to locate the point of convergence Xp at or near the user's face.

When considered in plan view in the upright use position of the screen 1, an included angle AXp facing towards the recess 2 may be defined between two imaginary straight lines Xp1, Xp2, each extending from a respective one of the free edges 22, 32 of the side portions 20, 30 to the point of convergence Xp.

The geometry of the screen and the positions and orientations of the cameras may be selected so that (when considered in plan view, which is to say, as if projected onto a horizontal plane)—when the point of convergence Xp is adjusted to the user's position relative to the screen 1, the included angle AXp may be at least 114°. This corresponds to the typical human binocular horizontal angular field of view and so minimises distraction to the user U by ensuring that anything visible beyond the free edges 22, 32 will be outside the binocular field of vision and so relatively less distracting.

At the same time, the overall dimensions of the screen are preferably selected so that the screen provides this degree of privacy or seclusion without being claustrophobic, thus helping the user to focus on the test (e.g. snack food 300, FIG. 9) while remaining relaxed in a familiar environment.

For this end it is preferred that the height H11, H21, H31 of the respective front surface 11, 21, 31 of each portion 10, 20, 30 is from 350 mm to 650 mm, and the width W11 of the front surface 11 of the middle portion 10 is from 350 mm to 1500 mm.

### Microphones

The apparatus may include at least one microphone 61, 71 for capturing sound data local to the fields of view F210, F220, F230 of the cameras 210, 220, 230, wherein the data management means 50 is arranged to store the sound data captured by the at least one microphone 61, 71.

The screen 1 may be configured (e.g. by making it from suitable materials) to help exclude extraneous noise from the or each microphone.

Referring also to FIG. 4, the at least one microphone may include at least one in-ear microphone 61 which is arranged in a respective in-ear housing 62 configured to be worn, in use, in an outer ear canal of a user U as shown in FIG. 9.

The in-ear microphone 61 may be configured to capture the sound data by bone conduction via the jaw of the user U, for example, by mounting it to receive vibrations conducted through the housing 62. Suitable in-ear microphones are known in the art, for example, as mentioned in Papapanagiotou V et al, above. Commercially available earbuds however are found to provide good quality sound data as further discussed below.

The at least one microphone may further include at least one local microphone 71 which is mounted in or on the screen 1. This can capture sound transmitted in air to produce sound data that is comparable with the sound data from the in-ear microphone 61, making it possible to compare the sound experienced by the user U eating a food item with that experienced by a person nearby.

The sound data from the local microphone 71 can be correlated with the sound captured (e.g. by bone conduction) by the in-ear microphone 61. This can help in comparing the sound generated by eating the food item and experienced through different modes of sensory perception. For example low frequency sound transmitted via bone conduction can indicate the crunchiness of the food item, while higher frequency sound transmitted in air can indicate the crispiness of the food item. Preferably the multiple sound data files are correlated temporally by the data management means 50 (which may be separate or integral with the cameras or earbuds or connected devices) as further discussed below.

The in-ear housing 62 provides a convenient way to obtain a mechanical connection to the head so as to capture the sound of chewing by bone conduction, while avoiding any cumbersome mechanical connection to the head which could be distracting to the test subject U.

The in-ear housing 62 however may act as an earplug, blocking ambient sound that normally would enter the ear via the outer ear canal.

In consequence, the user U may hear the sound of their own chewing as more than usually dominant, which in turn may affect their behaviour.

To avoid this unwanted effect, the apparatus may further include at least one ambient microphone for capturing ambient sound proximate the in-ear housing 62, and a speaker 64 that is arranged in the in-ear housing 62 to reproduce the ambient sound captured by the ambient microphone while the in-ear microphone 61 captures the sound data.

The ambient microphone captures a sound signal representing ambient sound which is then reproduced by the in-ear speaker 64, so as to enable the user to hear the ambient sound that they would normally hear if their ear canal were not blocked by the in-ear housing 62.

The ambient microphone can be the local microphone 71 or can be an ambient microphone 63 that is incorporated in the in-ear housing 62. The ambient microphone 63 can be external to the ear canal in use so that it captures ambient sound proximate the ear.

This functionality is available in commercial earbuds that support “transparency” mode.

Suitable commercial earbuds include the Apple Inc.® Airpod® or Beats®, which have additional audio signal processing and wireless transmission features.

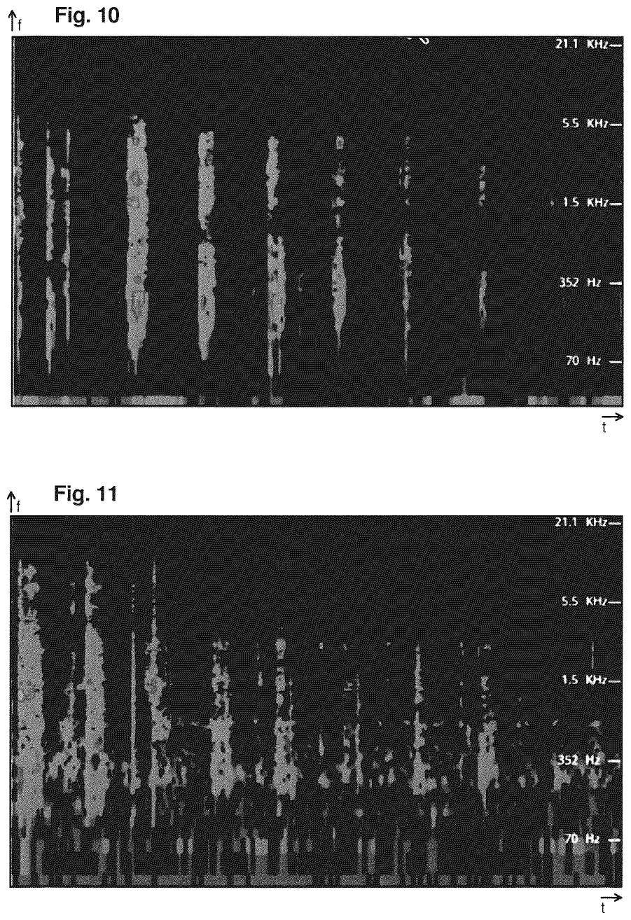

FIGS. 10-14 illustrate the sound data collected during tests of snack food 300 using the screen 1 as shown in FIG. 9.

FIG. 10 shows the sound (frequency f over time t) captured by the in-ear microphone 61 of an Apple® Airpod® earbud when worn by the user U while sitting in front of the screen 1 and chewing on a corn snack during an edible product test as illustrated in FIG. 9.

FIG. 11 shows the sound captured by the local microphone 71 during the same test. The local microphone was mounted on top of the middle portion 10 of the screen 1 rather than inside the middle portion 10 as illustrated. The test conditions were the same as for FIG. 10. The trace shows the different quality of sound transmitted in air compared with the sound captured from the in-ear microphone 61.

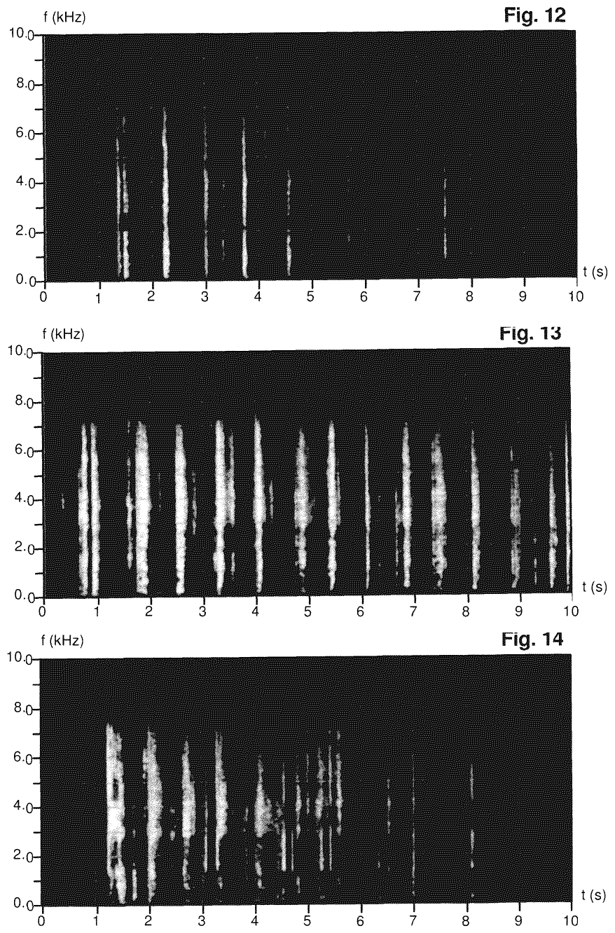

FIGS. 12, 13 and 14 show the sound (frequency f in kHz over time t in seconds) captured by the in-ear microphones 61 of a pair of Apple® Beats® earbuds worn by the user U when sitting in front of the screen 1 during further edible product tests as illustrated in FIG. 9. The figures illustrate the different sound profiles obtained from different snack foods in the test, which were respectively: almonds (FIG. 12), hard crackers (FIG. 13), and potato crisps (FIG. 14).

### Power Supply and Data Management

The apparatus further includes a power supply means 40 for supplying power to the cameras, and a data management means 50, including a memory 51, for collecting and storing the image data captured by the cameras 210, 220, 230. Either or both of the power supply means 40 and the data management means 50 may be integral to the screen or external to the screen or partially integral and partially external.

The power supply means can be any apparatus (i.e., a power apparatus capable of supplying power to the cameras, including for example a battery or supercapacitor or a solar panel or a generator or a grid connection to an external power supply.

The power supply means 40 may include at least one battery 41 located in the screen 1, and optionally, may include a separate battery for each camera (not shown). The battery or batteries may be rechargeable via a charging port (not shown) provided in a surface of the screen 1. A power supply that is self-contained within the screen 1, either shared between the cameras or individual to each camera, is preferred for portability. Alternatively however, the power supply means 40 may include a cable connector for connection to an external power supply in use.

The data management means 50 can be any apparatus including at least a memory 51 for collecting and storing the data, including for example any wireless or wired data transmission arrangement for receiving the data and directing the data to the memory. The memory 51 may be any device capable of storing data, for example, a memory card, a hard drive, or an external or remote data storage facility.

The data management means 50 may be arranged to temporally correlate the image data captured by the cameras 210, 220, 230, which is to say, to correlate the image data in time. It may store the image data so that each image or each frame of each moving image can be correlated as a time series with the simultaneously captured images or frames of the data collected by the other cameras, as well known in the art, thus providing a set of images taken from different angles that can be analysed together to identify the user's varying response from moment to moment, e.g. to a product under test.

Where sound data is collected, the data management means 50 may be arranged to temporally correlate the image data and the sound data, so that individual pieces of data from the different respective data streams can be related in time. The data management means may temporally correlate multiple sound data streams (and multiple image data streams) from different microphones and different cameras, and may include (or consist of) software or hardware integrated into the microphones (e.g. commercially available earbuds) or cameras or supporting devices such as cellphone apps.

The cameras may be portable cameras of the type designed to be worn on a helmet or the like, including an integral battery and data storage memory, e.g. a memory card. Each camera may include a lens and an image generating element, e.g. a charge coupled device. The data management means 50 may be partially or entirely integral to the cameras, for example, circuitry or hardware and optionally also software for receiving data from the image generating element of the camera and storing it in the memory, whether on-board the camera or external to the camera.

The data management means 50 may be arranged to extract the data from the on-board data storage means of the cameras and/or earbuds and/or connected devices and to transmit the data (wirelessly or via a wired connection) to a memory external to the screen 1, e.g. to a smartphone which can store the data locally or transmit it on to a server or remote data processing means.

For example, the cameras may be connected together and activated by a compatible, commercially available remote control device that synchronizes the cameras with each other and with compatible commercial earbuds which are connected wirelessly, e.g. via near field communications. Suitable cameras include the GoPro®.

The apparatus may further include a data processing means 500 such as a program running on a processor and configured to process the data to assess at least one of: a muscular action of the user U, and an affective reaction of the user U. Suitable programs are known in the art.

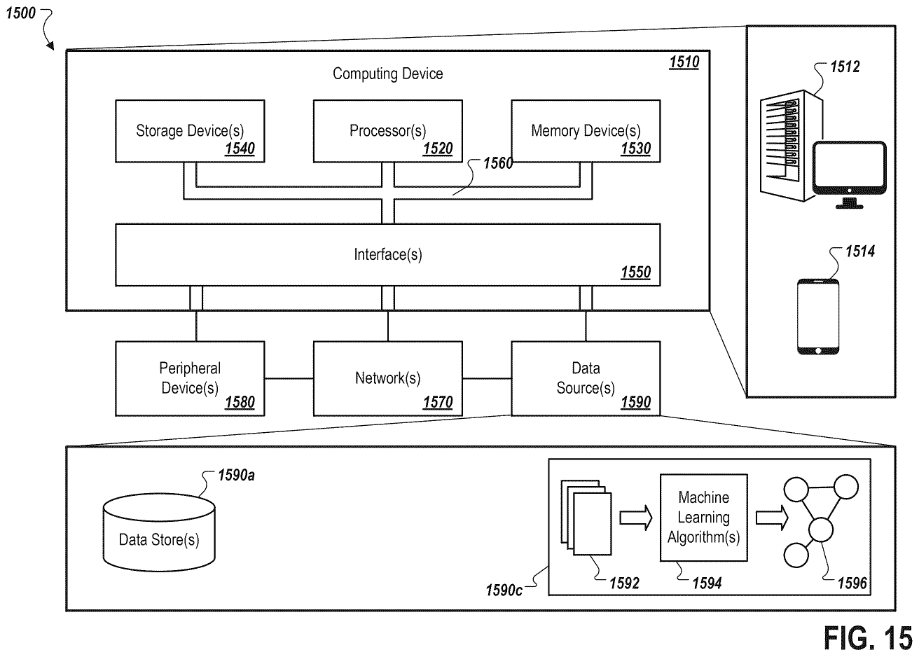

Referring to FIG. 15, the data management means may be implemented as a computing system 1500 that can be used to implement the described techniques. The computing system 1500 includes one or more computing devices (e.g., computing device 1510), which can be in wired and/or wireless communication with various peripheral device(s) 1580, data source(s) 1590, and/or other computing devices (e.g., over network(s) 1570). The computing device 1510 can represent various forms of stationary computers 1512 (e.g., workstations, kiosks, servers, mainframes, edge computing devices, quantum computers, etc.) and mobile computers 1514 (e.g., laptops, tablets, mobile phones, personal digital assistants, wearable devices, etc.). In some implementations, the computing device 1510 can be included in (and/or in communication with) various other sorts of devices, such as data collection devices (e.g., devices that are configured to collect data from a physical environment, such as the described microphones and cameras or scanners, sensors, etc.). Each of the devices (e.g., stationary computers, mobile computers, and/or other devices) can include components of the computing device 1510, and an entire system can be made up of multiple devices communicating with each other. For example, the computing device 1510 can be part of a computing system that includes a network of computing devices, such as a cloud-based computing system, a computing system in an internal network, or a computing system in another sort of shared network. Processors of the computing device (1510) and other computing devices of a computing system can be optimized for different types of operations, secure computing tasks, etc. The components shown herein, and their functions, are meant to be examples, and are not meant to limit implementations of the technology described and/or claimed in this document.

The computing device 1510 includes processor(s) 1520, memory device(s) 1530, storage device(s) 1540, and interface(s) 1550. Each of the processor(s) 1520, the memory device(s) 1530, the storage device(s) 1540, and the interface(s) 1550 are interconnected using a system bus 1560. The processor(s) 1520 are capable of processing instructions for execution within the computing device 1510, and can include one or more single-threaded and/or multi-threaded processors. The processor(s) 1520 are capable of processing instructions stored in the memory device(s) 1530 and/or on the storage device(s) 1540. The memory device(s) 1530 can store data within the computing device 1510, and can include one or more computer-readable media, volatile memory units, and/or non-volatile memory units. The storage device(s) 1540 can provide mass storage for the computing device 1510, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1550 can include various communications interfaces (e.g., USB, Near-Field Communication (NFC), Bluetooth, WiFi, Ethernet, wireless Ethernet, etc.) that can be coupled to the network(s) 1570, peripheral device(s) 1580, and/or data source(s) 1590 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1550 can include a control interface that receives commands from an input device (e.g., operated by a user) and converts the commands for submission to the processors 1520. The interface(s) 1550 can include a display interface that includes circuitry for driving a display to present visual information to a user. The interface(s) 1550 can include an audio codec which can receive sound signals (e.g., spoken information from a user as well as other sounds received by the microphones) and convert it to usable digital data. The audio codec can likewise generate audible sound, such as through an audio speaker. Such sound can include real-time voice communications, recorded sound (e.g., voice messages, music files, etc.), and/or sound generated by device applications. In some implementations, the disclosed technology may include image, audio, and/or data compression and decompression capabilities to allow for more efficient transmission of data, such as in low-bandwidth environments.

The network(s) 1570 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1510 can communicate with the peripheral device(s) 1580, the data source(s) 1590, and/or other computing devices over the network(s) 1570. In some implementations, the computing device 1510 can directly communicate with the peripheral device(s) 1580, the data source(s), and/or other computing devices.

The peripheral device(s) 1580 can provide input/output operations for the computing device 1510. Input devices (e.g., keyboards, pointing devices, touchscreens, microphones, cameras, scanners, sensors, etc.) can provide input to the computing device 1510 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1510 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1590 can provide data for use by the computing device 1510, and/or can maintain data that has been generated by the computing device 1510 and/or other devices (e.g., data collected from sensor devices, data aggregated from various different data repositories, etc.). In some implementations, one or more data sources can be hosted by the computing device 1510 (e.g., using the storage device(s) 1540). In some implementations, one or more data sources can be hosted by a different computing device. Data can be provided by the data source(s) 1590 in response to a request for data from the computing device 1510 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1590a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more machine learning systems 1590c. The machine learning system(s) 1590c, for example, can be used to analyze data from various sources (e.g., data provided by the computing device 1510, data from the data store(s) 1590a, and/or data from other data sources), to identify patterns in the data, and to draw inferences from the data patterns. In general, training data 1592 can be provided to one or more machine learning algorithms 1594, and the machine learning algorithm(s) can generate a machine learning model 1596. Execution of the machine learning algorithm(s) can be performed by the computing device 1510, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

In summary, embodiments of the described apparatus provide a hand portable screen 1 comprising three portions 10, 20, 30 connected in series relation, e.g. jointed or integrally formed, each portion having a camera 210, 220, 230 for capturing image data from a field of view in front of a front surface 11, 21, 31 of the respective portion of the screen. The screen 1 is free standing when configured in an upright use position on a horizontal surface, e.g. a tabletop, so that the three front surfaces 11, 21, 31 form three sides of a forwardly open recess 2. The side portions 20, 30 may be adjustable to converge the fields of view on a user U sitting in front of the screen 1, for example, during an edible product test. Microphones 61, 71 may be provided, optionally in-ear, to capture sound data simultaneously with the image data from the cameras. The screen may be deployed to provide an individual test environment, for example, for testing snack food in an informal location.

In some instances, as exemplified by the illustrated embodiment, the side portions are movably connected to the central portion so that the three portions remain connected together in the compact configuration. As illustrated, the connections may be arranged so that the three portions remain in series relation in both the use configuration and the compact configuration. By arranging all three portions as substantially flat, rigid, rectangular bodies connected together by hinges, the apparatus is made particularly compact and convenient in use.

In alternative embodiments however, the three portions may be separable and assembled together in the use configuration.

In alternative embodiments, instead of hard panels, the respective portions of the screen may be parts of a flexible body, e.g. made from fabric supported or stretched on or over a frame, which may be folded or rolled to the compact configuration. In such arrangements the front surfaces of the three portions may form parts of a continuous common front surface of the screen.

Rather than hinging the portions so that the screen is pivotably foldable, the portions could be made to extend telescopically so that one or more portions are housed inside another one or more portions in the compact configuration. In such arrangements the portions may be connected together permanently but may only be arranged in series relation when extended to the use configuration.

In this and other arrangements the portions (and their front surfaces) may be curved rather than flat.

In alternative embodiments the screen may include more than three portions.

It will be understood that the front surfaces of the screen need not include any active display means. However, if desired, one or more portions of the screen may include a display, such as an electronic display for moving images or the like, which may provide a focus point for the user to assess how the user's interaction with an edible product under test may vary when watching television or the like.

Of course, the screen may be used for testing products other than edible products, and for purposes other than product testing.

Many further adaptations are possible within the scope of the claims.

In the claims, characters are provided in parentheses, purely for ease of reference, and should not be construed as limiting features.

1. An apparatus including:
a screen;
the screen being hand-portable and extendible from a compact configuration to a use configuration;
wherein in the use configuration the screen is configured to be freestanding in an upright use position on a horizontal flat surface;
the screen including a middle portion and two side portions, with each of the portions having a respective front surface; that terminates at a respective free edge, wherein each of the front surfaces have a respective height and width, and wherein in the upright use position the height extends in a vertical dimension and the width extends in a horizontal dimension;
each of the portions have a thickness smaller than the height and width of the respective front surface;
the portions being connected together in series relation in the use configuration, wherein:
the front surface of the middle portion extends in its width between the front surfaces of the two side portions, and
the front surface of each side portion extends in its width between its respective free edge and the front surface of the middle portion;
wherein in the upright use position the front surfaces define three inwardly facing sides of a recess, with the recess having a front opening bounded by the free edges of the side portions, the front opening having a width between the free edges greater than the width of the front surface of the middle portion;
each portion of the screen including a respective camera being arranged to capture image data from a respective field of view in front of the respective front surface;
the apparatus further including:
a power supply means for supplying power to the cameras, and
a data management means, including a memory, for collecting and storing the image data captured by the cameras.

2. The apparatus according to claim 1, wherein the height of the respective front surface of each portion is from about 350 mm to about 650 mm, and the width of the front surface of the middle portion is from about 350 mm to about 1500 mm.

3. The apparatus according to claim 1, wherein the camera of each portion is arranged behind the respective front surface.

4. The apparatus according to claim 1, further including at least one microphone for capturing sound data local to the fields of view of the cameras, the data management means being arranged to store the sound data captured by the at least one microphone.

5. The apparatus according to claim 4, wherein the data management means is arranged to temporally correlate the image data and the sound data.

6. The apparatus according to claim 4, wherein the at least one microphone includes at least one in-ear microphone being arranged in a respective in-ear housing configured to be worn, in use, in an outer ear canal of a user.

7. The apparatus according to claim 6, wherein the at least one microphone further includes at least one local microphone being mounted in or on the screen.

8. The apparatus according to claim 6, wherein the apparatus further includes at least one ambient microphone for capturing ambient sound proximate the in-ear housing, and a speaker arranged in the in-ear housing and arranged to reproduce the ambient sound captured by the ambient microphone while the in-ear microphone captures the sound data.

9. The apparatus according to claim 1, wherein the power supply means includes at least one battery located in the screen.

10. The apparatus according to claim 1, wherein, when considered in plan view in the upright use position, the front surfaces of the side portions are mirror-symmetric about a vertical plane (Pv) bisecting, and perpendicular to, the front surface of the middle portion.

11. The apparatus according to claim 1, wherein, when considered in plan view in the upright use position of the screen, respective central axes of the fields of view of the cameras of at least the side portions converge at a point of convergence (Xp) located outside the recess.

12. The apparatus according to claim 11, wherein the side portions are angularly adjustable, relative to the middle portion, to vary, simultaneously, in the upright use position:
the width of the front opening, and
a distance (DXp) of the point of convergence (Xp) from the middle portion.

13. The apparatus according to claim 11, wherein, when considered in plan view in the upright use position of the screen, an included angle (AXp) of at least 114° and facing towards the recess is defined between two imaginary straight lines (Xp1, Xp2), each extending from a respective one of the free edges of the side portions to the point of convergence (Xp).

14. The apparatus according to claim 1, wherein the side portions are pivotably connected to the central portion and foldable to the compact configuration; wherein, in the compact configuration, the front surfaces of the side portions are arranged in confronting relation to the front surface of the middle portion.

15. The apparatus according to claim 14, wherein the width of the front surface of each of the side portions is approximately half of the width of the front surface of the middle portion.

16. The apparatus according to claim 1, wherein the camera of each portion is arranged behind the respective front surface to capture image data through a transparent portion of the respective front surface or through an aperture formed in the respective front surface.

17. The apparatus according to claim 1, wherein the camera of each portion is arranged behind the respective front surface to capture image data through a transparent portion of the respective front surface, and each portion is arranged to define a respective cavity containing the respective camera, and to substantially exclude ambient light from entering the cavity other than via the transparent portion of the respective front surface.

18. The apparatus according to claim 1, wherein a central axis of the field of view of the camera of each of the side portions intersects the front surface of the respective side portion at a respective location point less than 30% of the width of the front surface of the respective side portion from the free edge of the respective side portion.

19. The apparatus according to claim 18, wherein each location point is less than 30% of the height of the respective front surface of the respective side portion from an upper edge of the respective side portion when considered in the upright use position.

20. The apparatus according to claim 1, further including a data processing means configured to process the data to assess at least one of: a muscular action of the user and an affective reaction of the user.
